(19) United States
(12) Patent Application Publication
(10) Pub. No.: US 2002/0063428 A1
(43) Pub. Date: May 30, 2002

(54) Protective packing structure for a cylindrical object and fitted with a fastener

(76) Inventors: Thierry Birkel, Vandoeuvre Les Nancy (FR); Serge Arduini, Heillecourt (FR)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/950,922

(22) Filed: Sep. 13, 2001

(30) Foreign Application Priority Data
Sep. 14, 2000 (FR) 0011703

(51) Int. Cl. F16L 19/00; F16L 21/02

(52) U.S. Cl. 285/377

(57) ABSTRACT

The invention relates to a packing structure protecting a cylindrical object and comprising an integrated fastener, said packing structure assuming the form of a collar hooping the object to be protected and being characterized in that said collar comprises over at least a large portion of its periphery at least one at least partly closed housing (4) which is designed to receive and retain on the collar said fastener (2) which shall enclose and tighten said collar, said housing illustratively being a channel fitted with two lips, said fastener (2) being inserted between these lips.

In one embodiment mode of the invention of the packing structure protecting the end of a cylindrical object, the collar is fitted with a substantially right-angle flange (5) covering the end segment of said object to be protected.

The invention relates to a protective packing structure for a cylindrical object and fitted with an integrated fastener.

In order to protect the ends of a cylindrical object such as a pipe, a coil or the like when being shipped or stored, said end heretofore has been enclosed by an angled protector or a case affixed by a hoop.

Such a protective means which does not specifically match the diameter of the object to be protected and which while hooping must be kept in placed and must be handled simultaneously with its hooping means manifestly offers questionably efficacy and foremost hampers handling.

In some applications and as is known form the British patent 834,061, a cylindrical-object protective packing structure is known which comprises an integrated fastener and which assumes the shape of a collar hooping the object to be protected. This packing structure consists of a layer of wood chips, said layer being clad by a cloth, a wire being inserted between said layer of chips and the inside surface of said cloth.

In this embodiment, the tension in the wire should be maintained while the layer of chips expands and contracts. Obviously this technique also entails a multilayer composite of specific materials.

Therefore the inventors' goal has been a practical and efficient means which matches homogeneous as well as inhomogeneous materials.

For that purpose the inventors conceived a protective packing structure for a cylindrical object, fitted with an integrated fastener and in the form of a collar retaining the said object but being characterized in that it is fitted at least over a large portion of its periphery with at least one at least partly closed housing to receive an retain at the collar the said fastener enclosing and clamping it.

Advantageously the fastener is a hoop or the like whereas the collar is a strip of which the length is selected in relation to the desired collar diameter and of which the ends are joined to one another.

Illustratively the collar-constituting strip is made of plastic and its ends are mutually fused together.

The collar's housing may be away from the ends' junction to keep these ends free.

In one embodiment mode, the housing retaining the fastener consists of a channel on the collar's periphery, said channel comprising two lips partly closing it and the fastener being inserted between these lips.

The fastener's retaining housing also may be in the form of an elongated cap on the collar periphery which is bent onto said fastener and is fused at its free tip, or said retention housing may be a closed space on or in the collar's periphery to receive said fastener.

Preferably at least the inside collar surface that shall be in contact with the object to be protected shall be fitted with an anti-slip cladding and/or with protrusions or salients and/or the collar material shall be at least partly an anti-slip material.

It is understood that a packing structure of the invention may be used at different sites on the cylindrical object to be protected.

However, when protecting the end of a cylindrical object, the collar shall advantageously comprise a substantially right-angle flange to cover the end segment of the object to be protected.

In the latter case, the right-angle flange advantageously shall be fitted with regularly recurring cutouts to allow the flange to bend and according to one embodiment mode, the cutouts of this flange shall be a sequence of isosceles trapezoids, the edge subtended between the collar and its right-angle flange for instance being reinforced by an external rib.

In another embodiment of the invention, the collar comprises a thinner edge opposite its right-angle flange.

The invention and its other features are elucidated in the following description and in relation to the attached drawings.

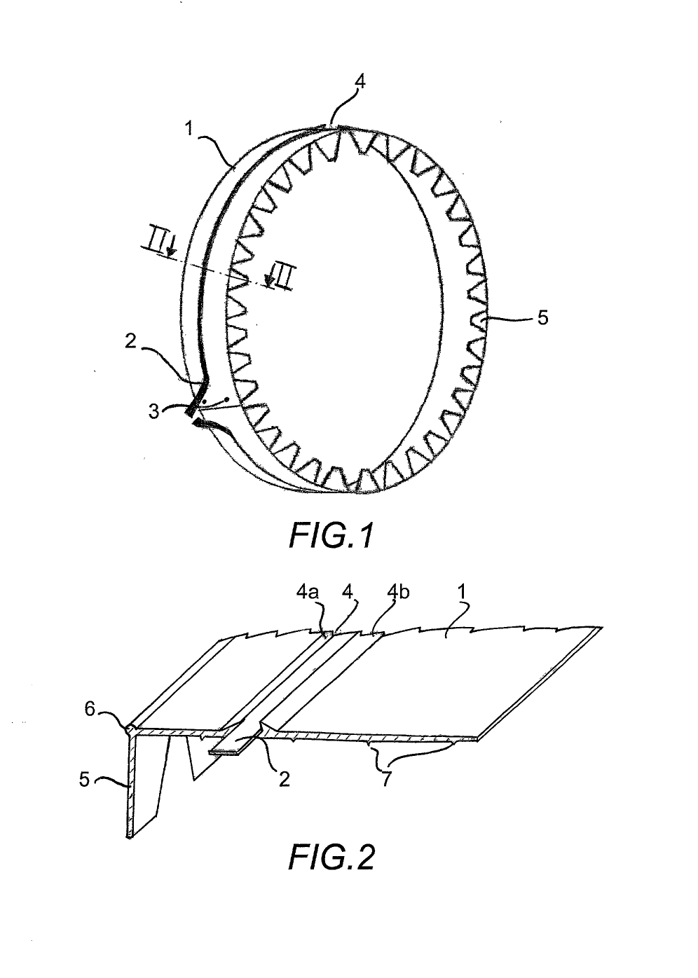

FIG. 1 is a perspective of one embodiment of the invention,

FIG. 2 is a perspective section along II-II of FIG. 1,

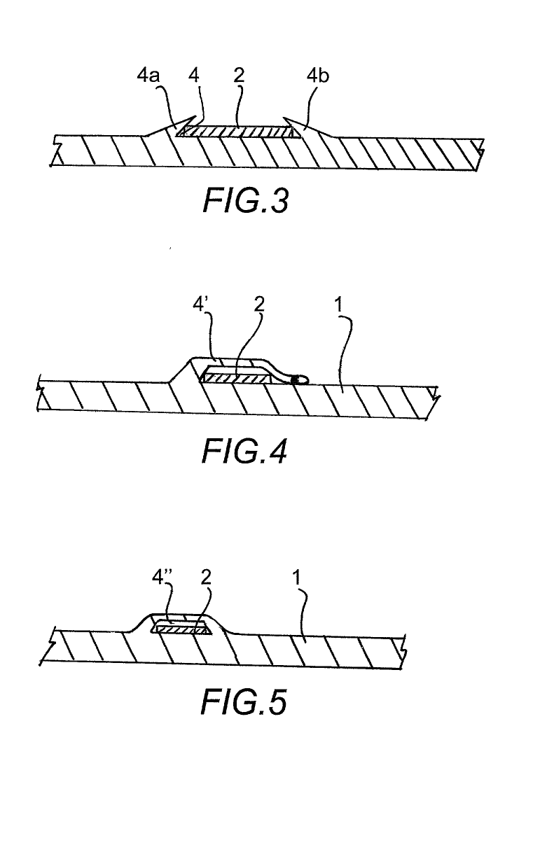

FIG. 3 is a partial enlargement and an elevation of FIG. 2,

FIGS. 4, 5 correspond to FIG. 3 and are slight embodiment variations.

FIG. 1 shows a packing structure of the invention in the form of a collar made from of a strip 1 for instance of polyethylene, polypropylene, cardboard or other material, said strip being fitted with a housing to seat a fastener such as a hoop 2.

The strip ends are joined to each other in relation the collar's diameter, for instance by fusion especially as regards a plastic as indicated by 3 in FIG. 1.

The hoop's housing illustratively assumes the form of a channel 4 (FIGS. 1 through 3) or of a cap 4′ (FIG. 4) covering the collar and above said hoop and fused by its free end, or in the form of a closed space 4″ (FIG. 5).

As shown in FIG. 1, the hoop's housing 4 runs circularly over a large portion of the collar.

However, and as also shown in FIG. 1, the channel 4 is eliminated at and near the fusion 3 of the ends of the strip 1 for the purpose of freeing the hoop's ends which shall be mutually affixed by any known means (collar . . . ) after said hoop has been tightened.

As regards the more specific embodiment of FIGS. 1 through 3, the channel 4 consists of two lips 4a, 4b partly closing said channel and retaining the hoop after its insertion between them (illustratively near the fusion 3, the lips 4a, 4b shall be trimmed to eliminate the channel 4 for the above reasons).

While, in this embodiment mode, the lips 4a, 4b do subtend said channel 4, this channel of course also may be subtended within the strip and comprise lip forming edges.

It is understood that such a collar may enclose and clamp any cylindrical object such as a pipe, a tube, a coil or the like in order to protect it, though specifically the invention is intended to protect the end of such a cylindrical object.

For that purpose the strip 1 that shall constitute the collar is fitted with a substantially right-angle flange 5 which preferably shall be cut out at regular spacings to allow bending it around a circular edge.

In the shown embodiment mode, the cutouts of the right-angle flange 5 are a series of isosceles trapezoids.

Furthermore, FIG. 2 shows that the edge joining the collar to the right-angle flange 5 is reinforced by an external rib 6.

FIG. 2 shows that, in order to easily put the collar on the object, the collar edge opposite the flange 5 is thinner, in this instance by means of a bevel from its inside surface to its upper surface.

Ast least the collar's inside surface may be fitted with an anti-slip cladding and/or protrusions or salients such as 7 (FIG. 2) in order to assure gripping the object to be protected. Instead, or in addition, the material used for the collar may be at least in part an anti-slip material.

Many embodiment variations manifestly may be employed without thereby transcending the scope of the present invention.

Also, when the above described embodiment includes a hoop, this term must be construed broadly, and this hoop of course also may be replaced by any other means such as a plastic tape, a cable etc.

1. A protective packing structure for a cylindrical object, fitted with an integrated fastener, in the form of a collar hooping the object to be protected, characterized in that said collar comprises at least one housing (4, 4′, 4″) over at least a large portion of its periphery, said housing being at least partly closed and designed to receive and retain onto the collar the fastener (2) used to enclose and tighten said collar.

2. Packing structure as claimed in claim 1, characterized in that the fastener is a hoop (2) or the like.

3. Packing structure as claimed in either of claims 1 and 2, characterized in that the collar is in the form of a strip (1) of which the length is selected in relation to the desired strip diameter and of which the ends are affixed to each other.

4. Packing structure as claimed in claim 3, characterized in that the collar-constituting strip (1) is made of plastic and its ends are mutually fused.

5. Packing structure as claimed in either of claims 3 and 4, characterized in that the collar is devoid of a housing (4, 4′, 4″) in the vicinity of the junction of its ends in order to free the ends of the fastener (2).

6. Packing structure as claimed in one of claims 1 through 5, characterized in that the housing retaining the fastener (2) consists of a channel (4) subtended in the collar's periphery and comprising two lips (4a, 4b) which partially close said channel, said fastener (2) being inserted between said two lips.

7. Packing structure as claimed in one of claims 1 through 5, characterized in that the housing retaining the fastener (2) is subtended by a cap (4′) situated on the collar's periphery and covering said fastener (2) and fused at its free end segment.

8. Packing structure as claimed in one of claims 1 through 5, characterized in that the housing retaining the fastener (2) is subtended by a closed space (4″) situated on or in the collar's periphery, the said fastener (2) being inserted into said closed space.

9. Packing structure as claimed in one of claims 1 through 8, characterized in that at least the collar's inside surface that shall be in contact with the object to be protected will be fitted with an anti-slip cladding.

10. Packing structure as claimed in one of claims 1 through 9, characterized in that at least the collar's inside surface that shall make contact with the object to be protected is fitted with protrusions or salients (7).

11. Packing structure as claimed in one of claims 1 through 10, characterized in that at least part of the collar material shall be anti-slip.

12. Packing structure as claimed in claims 1 through 11 to protect the end of a cylindrical object, characterized in that the collar is fitted with a substantially right-angle flange (5) covering the end segment of said object to be protected.

13. Packing structure as claimed in claim 12, characterized in that the right-angle flange (5) is cut out in regularly recurring manner to allow bending it.

14. Packing structure as claimed in claim 12, characterized in that the collar's right-angled flange (5) constitutes a sequence of isosceles trapezoids.

15. Packing structures claimed in one of claims 12 through 14, characterized in that the edge constituting the junction between the collar and its right-angle flange (5) is reinforced by an external rib (6).

16. Packing structure as claimed in one of claims 12 through 15, characterized in that the collar comprises a thinned edge on the side opposite its right-angle flange (5).
